(19) United States
(12) Patent Application Publication
(10) Pub. No.: US 2017/0113954 A1
(43) Pub. Date: Apr. 27, 2017

(54) System for Conditioning, Energizing, and Oxygenating Water

(71) Applicant: Decauter Stoppelbein, Mount Aukum, CA (US)

(72) Inventor: Decauter Stoppelbein, Mount Aukum, CA (US)

(21) Appl. No.: 14/918,576

(22) Filed: Oct. 21, 2015

(51) Int. Cl. C02F 1/72; C02F 1/48; B01F 3/04

(52) U.S. Cl. CPC C02F 1/72; B01F 3/04099; C02F 1/482; C02F 1/481; B01F 2215/0052; B01F 2003/04914; B01F 2003/04851; B01F 2003/04943; C02F 2303/00

(57) ABSTRACT

This invention relates to a method and an apparatus for energizing and aerating fluids, comprising the step of subjecting a starting liquid to a process in order to produce an energized liquid the molecules of which are clustered and can have a specific wavelength, magnetic field, and hydrating properties.

Water charging machine wherein the water being treated is moved through a geometric series of spheres, creating a series of waterfall-like events within this invention. Oxygen may be introduced into the stream of water either upstream of this invention, or into the inside of this invention, or both, to provide a long shelf life incorporation of the gaseous oxygen into the water through vortex and waterfall actions. The water and oxygen is also exposed to a negative or positive magnetic field and a piezoelectric field as it travels through this invention, to provide a substantial Zeta potential.

### CROSS REFERENCE TO RELATED APPLICATIONS

Not Applicable

### STATEMENT REGARDING FEDERALLY SPONSORED RESEARCH OR DEVELOPMENT

Not applicable.

### TECHNICAL FIELD OF THE INVENTION

This invention relates in general to the field of water and fluid conditioning. More specifically, this invention relates to a method of improving the quality and the conditions of water, as well as any liquid substance that contains water as part of its chemistry.

The present invention refers to a water-conditioning device allowing spatial reorganization of water molecules and increasing the level of molecular order. So that the water by the mere passage through the systems becomes energized, magnetized, thereby attaining different energetic and structural molecular properties. This water is seen as more energy efficient and thus biologically more active and desirable.

The present invention also refers to a water purification device, allowing water to pass over materials that will change and absorb unwanted materials and chemicals from water.

This present invention also refers to an aeration device, for long-term capture and storage of gasses into liquids, most notably, the capture and storage of oxygen into water.

### BACKGROUND OF THE INVENTION

In nature, raindrops fall from clouds in the sky and the drops of water split apart and recombine countless times as they fall to the ground. The water droplet's chemical and electrical bonds are broken and re-combined countless times as they fall, spin, and crash into other rain drops on their way to the ground. This action of splitting and re-gathering of the raindrops on the rain's way to the Earth, results in the rainwater having different properties than the water that has been stored on the ground or in the ground. Rainwater is usually seen to have higher oxygen content and greater electromagnetic fields, and several other measurable chemical, physical/structural, and electromagnetic differences than water that has been stored on the earth's surface in lakes, storage tanks, ground water, or municipal tap water. This is largely due to the fact that raindrops are exposed and subjected to vast magnetic, electromagnetic, gravitational, centrifugal, and atmospheric forces as they fall, spinning splitting and hitting each other within the gasses such as oxygen, and the electromagnetic field present within the earth's atmosphere. These are several of the distinct chemical and electromagnetic circumstances that makes rainwater known to be much better for plant health, and is preferred by farmers, gardeners, and biologists, over ground water sources worldwide.

Naturally occurring spring and river-water have also undergone many of the same changes as rainwater that also makes them preferred for drinking and for agricultural uses. As river and/or spring water flows over and through stones and boulders, the bonds between water molecules vortex, break apart, and recombine countless times, all while being exposed to the air and oxygen of the environment, the electromagnetic fields of the sun, moon, the stars, the earth, and the environment, as well as the vibrational frequencies and magnetic fields of the stones, minerals, and metals which the water flows upon and which the Earth is made of. Through these vortexing flows, water is essentially folding and unfolding, and in this action it is both absorbing and releasing energy, chemicals, and gasses from and into its environment.

Several naturally occurring river, ground, and bedrock stones such as quartz, granite, and tourmaline create piezoelectricity. This means that the pressure and force of water flowing, as well as the weight of the stones stacked upon and compressing themselves, produces electricity from piezoelectric stones/crystals. The water naturally absorbs some of this electricity as it flows, vortexes, folding and unfolding over the curved surfaces of the stones. Natural and man-made magnets and magnetic fields can impart a magnetic field into the water as water flows over them. These stones and magnetic materials are also present inside of the Earth, so as spring water flows up to the surface, vast pressures, compressions, and magnetic fields are inherent, and these pressures and magnetic fields can act to induce piezoelectricity and magnetism into spring and river water. These factors contribute to spring and river water is vastly different from stagnant ground water, lake, stored, and municipal sources as well.

These waters, and waters that have been spun are preferred to farmers, nutritionists, and biologist worldwide for their increased cellular availability benefit to biological systems through rain, spring, and river water's increased electromagnetic activity, oxygen levels, and the coherent-geometric physical structure within it's molecular arrangements.

The enhanced electromagnetic and physical structural capacity and properties of these types of water are known scientifically and commonly as “vortexed”, “clustered” and “structured water”.

This water charging/structuring device acts upon the unstructured water, commonly known as tap or bulk water, containing disordered clusters i.e. distorted geometrical shapes of dipole water H2O molecules by using simultaneously both the magnetic field and the kinetic energy generated as a result of multiple, rotational and spiral flows of water through centrifugal forces of waterfall actions achieved by water flowing over the spheres in this device. During the water flow through the magnetic and piezoelectric field and the vortex actions induced, pressure forces are created causing together the compression of molecules and rearrangement of hydrogen bonds between water molecules resulting in a state of higher order, which restores the natural structured state of water.

Piezoelectricity is the ability of certain crystals to produce a voltage when subjected to mechanical stress. The word is derived from the Greek piezein, which means to squeeze or press. The effect is reversible; piezoelectric crystals, subject to an externally applied voltage, can change shape by a small amount. The effect is of the order of nanometers, but nevertheless finds useful applications such as the production and detection of sound, generation of high voltages, electronic frequency generation, and ultrafine focusing of optical assemblies.

In a piezoelectric crystal, the positive and negative electrical charges are separated, but symmetrically distributed, so that the crystal overall is electrically neutral. When a stress is applied, this symmetry is disturbed, and the charge asymmetry generates a voltage. A 1 cm cube of quartz with 500 lb (2 kN) of correctly applied pressure upon it, can produce 12,500 V of electricity.

A related property known as pyroelectricity, the ability of certain mineral crystals to generate electrical charge when heated, was known of as early as the 18th century, and was named by David Brewster in 1824. In 1880, the brothers Pierre Curie and Jacques Curie predicted and demonstrated piezoelectricity using tinfoil, glue, wire, magnets, and a jeweler's saw. They showed that crystals of tourmaline, quartz, topaz, cane sugar, and Rochelle salt (sodium potassium tartrate tetrahydrate) generate electrical polarization from mechanical stress. Quartz and Rochelle salt exhibited the most piezoelectricity. Twenty natural crystal classes exhibit direct piezoelectricity. Converse piezoelectricity was mathematically deduced from fundamental thermodynamic principles by Lippmann in 1881. The Curies immediately confirmed the existence of the “converse effect,” and went on to obtain quantitative proof of the complete reversibility of electro-elasto-mechanical deformations in piezoelectric crystals.

### PRIOR ART

In almost every system on earth consisting of, or incorporating, biological substances, water is the base or carrier of different functions and processes. Natural liquid water has an unpredictable structure consisting of both un-bonded and disordered water molecules connected to others related as bonded internal and surface clusters, all connected to each other by hydrogen bonding. Water is a non-reproducible resource and due to mankind's more and more extensive use of the nature the pressure to the environment stresses the water structures even more. Water clusters are a natural phenomenon itself, but the size and structure of the natural clusters cannot be predicted. The possibility of artificially energizing the water by forming a specified high-quality and replicable water cluster structures is therefore attractive for a variety of practical applications.

In the past a number of attempts have been made to produce clustered water artificially, including several designs for chambers that induce vortex action, light, and/or magnetism to water. Thus U.S. Pat. No. 5,711,950 discloses a process for preparing clustered water, comprising the steps of boiling water to produce steam and passing the steam across a magnetic field as well as exposing the steam to light having a wavelength of between 610 and 1 mm. This process is however rather complicated and expensive, and not suitable for producing clustered water industrially on a large scale.

U.S. Pat. No. 5,925,292 A: entitled Water charging machine, discloses a device and a process for preparing oxygenated water that has long-term shelf life. This device channels water that flows into it, into a double vortex. This vortexing water is exposed to magnetic fields derived by permanent magnets, and a piezoelectric field derived from the use of one quartz crystal.

Glass spheres have been set into tubes, in a pattern of 2×2, and are sold by 2 companies. These are simply glass spheres set into a tube, and have no patentability. These systems are simply passing water over the glass spheres that are set into a tube, in order to induce waterfall-type flows and effects to the water flowing through the tubes. These devices are neither novel nor patented, nor do not incorporate the piezoelectric, magnetic, or infrared materials under compression, as this invention incorporates.

Shower filters and small-scale water filters have been produced and marketed incorporating a similar mixing tube as this present invention details, and containing spheres that are designed to catch and trap water-borne chemicals. These devices use relatively large spheres inside of a relatively small mixing tube, and accomplish very little filtration and nothing to add an electricity or magnetism to the water. Therefore they are almost useless to any industrial or large-scale agricultural purpose. Those devices do not incorporate piezoelectric materials/spheres under compression, nor do they incorporate pyroelectric, pyroluminescent, magnetic, or infrared ceramics in this form or fashion. Nor do they incorporate gasses/oxygen into the water treated in those devices.

### SUMMARY OF THE INVENTION

The present invention disclosed and claimed herein comprises, in the primary aspect thereof, a method of treatment of water and other liquids for home and agricultural use. Liquid is first pumped from a reservoir into a pipe that flows the liquid into the “mixing station” that essentially comprises this invention. This mixing station is essentially a pipe that is filled of gemstone, metallic, mineral, ceramic, and magnetic spheres that have been compressed under torsion/pressure. Liquids are pumped over and through the mixing station and it is passed over and through these spheres causing the water molecules to split and re-assemble repeatedly as they pass over an array of several spheres. The gemstones and other material spheres present in the mixing station are piezoelectric, pyroelectric, and pyro-luminescent crystalline materials, as well as magnetic, magnetically conductive, and infrared producing materials. This creates an environment in which the water is forced to split rapidly and repeatedly as the liquid passes through these magnetic, electric, and luminous conditions that are present within the environment of the mixing station. The liquid exiting the mixing station is activated, electrically and magnetically charged, and can have altered physical, electromagnetic, and/or chemical properties. Water that has undergone similar treatments are known to the market as being “vortexed water”, “living water”, “liquid crystal water”, “clustered water”, “structured water”, as well as by several other trade and scientific names, and are preferred just as spring water is preferred for hydration and agricultural purposes.

Materials designed for filtration of liquids, or to induce other specific chemical, energetic, or physical changes to the water/fluids can be made into the form of spheres, and then placed into and incorporated into this invention and accomplish specific filtration tasks. Several forms of filtration are possible within the design and function of this invention, but the primary function of this device is to affect the physical properties of the liquids passing through it by the frequency, magnetism, electricity, and the luminosity that can be derived from compressing piezoelectric gemstone spheres, together with magnetic, infrared producing materials, and phosphorescent/luminous and pyroelectric materials.

Another function of this invention is to add O2 Oxygen, Hydrogen, and/or most any gas into water. Gas may be introduced into the liquid flowing through this invention by way of a valve that may be connected to this invention. The valve would connect to a hose and connect this invention to a tank of the gas can be used to pump desired gasses into this invention. This gas is pumped into the stream of water through a 1-way valve stem/pipe that can be used to pump gas into the water pipelines preceding this invention, or the gasses can be pumped directly into the body of this invention itself with a valve stem that can be connected to the body/mixing station of this invention. This gas will be induced into the water as the water folds, unfolds, vortexes, and spirals over and through the spheres contained in this invention. This is a very effective means of trapping gasses such as oxygen, with long-term shelf-life, into the water's molecular structure as it flows over and through the spheres contained inside of the body of this invention.

Any liquid has the potential to be affected or improved through this device's processes and materials involved. These liquids are then used for drinking, irrigation, preservation, cosmetics, nutrition, manufacturing and other natural and synthetic chemical processes.

### BRIEF DESCRIPTION OF THE DRAWINGS

FIG. 1 illustrates a perspective side-view of this invention as if the components involved were made of clear/transparent materials wherein 1 shows the body referred to as the mixing station of this invention. 2 shows the caps on the entry and exit points at the ends of the mixing station, and 3 illustrates the threaded pipe/tube/hose that allows fluid to enter and exit the mixing station, as well as applying compressive force onto the piezoelectric spheres 4 and the magnetic spheres 5. FIGS. 1-5 all show these main aspects of this invention, as well as the optional air/ gas entry valves 7 and examples of magnets and magnetic rings 6 that can be attached to the inside or outside mixing station 1.

FIG. 2 illustrate further embodiments of this invention.

FIG. 2 illustrates further embodiments of this invention.

FIG. 3 illustrates further embodiments of this invention.

FIG. 4 illustrates further embodiments of this invention.

FIG. 5 illustrates an alternative design for the mixing station 1 of this invention.

FIG. 6 illustrates a perspective top view of optional arrangements piezoelectric, mineral, and other material spheres 4, as well as magnetic spheres 5 within the mixing station 1 of this invention.

FIG. 7 illustrates a perspective top view of optional arrangements piezoelectric and other material spheres 4, as well as magnetic spheres 5 within the mixing station 1 of this invention.

FIG. 8 illustrates a perspective top view of optional arrangements piezoelectric and other material spheres 4, as well as magnetic spheres 5 within the mixing station 1 of this invention.

FIG. 9 illustrates a perspective top view of optional arrangements piezoelectric and other material spheres 4, as well as magnetic spheres 5 within the mixing station 1 of this invention.

FIG. 10 illustrates a perspective top view of optional arrangements piezoelectric and other material spheres 4, as well as magnetic spheres 5 within the mixing station 1 of this invention.

FIG. 11 illustrates the components composing the compressive end caps 2, and the threaded entry and exit pipes 3 that attach to the top and the bottom of the mixing station, and are the pipes 3 for liquid flowing through mixing station 1 this invention.

FIG. 12 illustrates the piezoelectric, ceramic, and other material spheres 4, as well as the magnetic spheres 5 that are to be placed and compressed within the mixing station of this invention

FIG. 13 illustrates the body of the mixing station 1.

FIG. 14 illustrates another compressive end cap 2 and pipe 3 that will cap the mixing station, and allow for liquids to flow into and through the mixing station, such as is illustrated as FIG. 11.

### DETAILED DESCRIPTION OF THE INVENTION

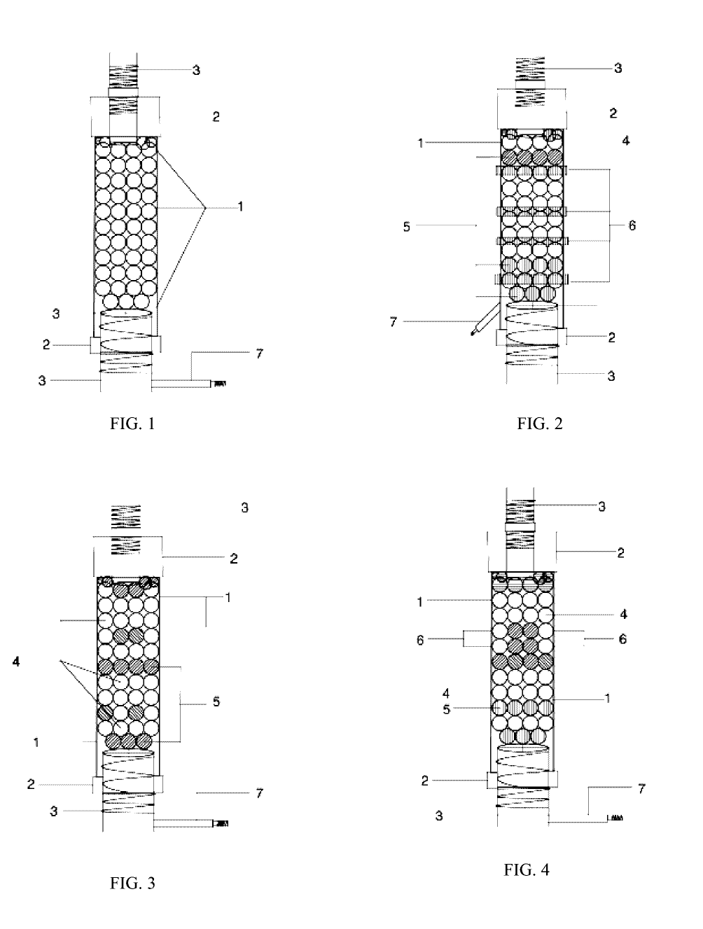

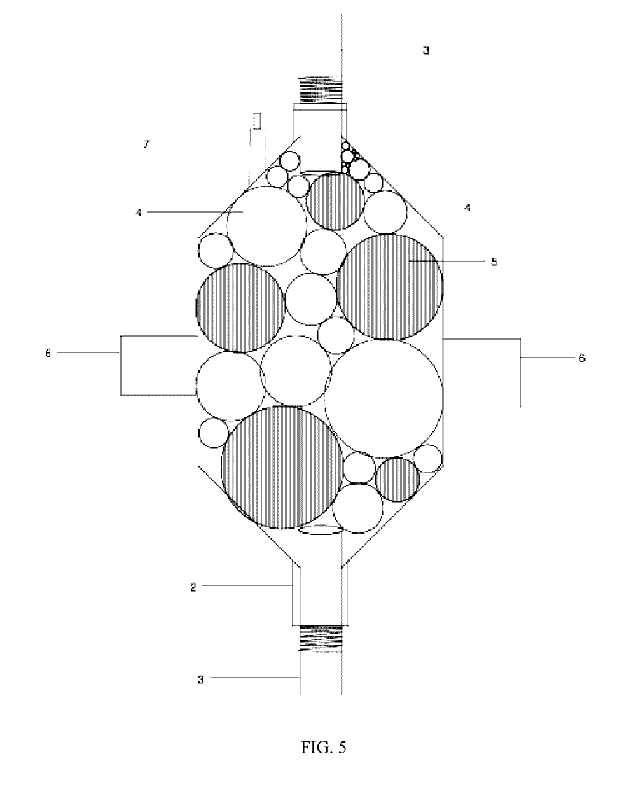

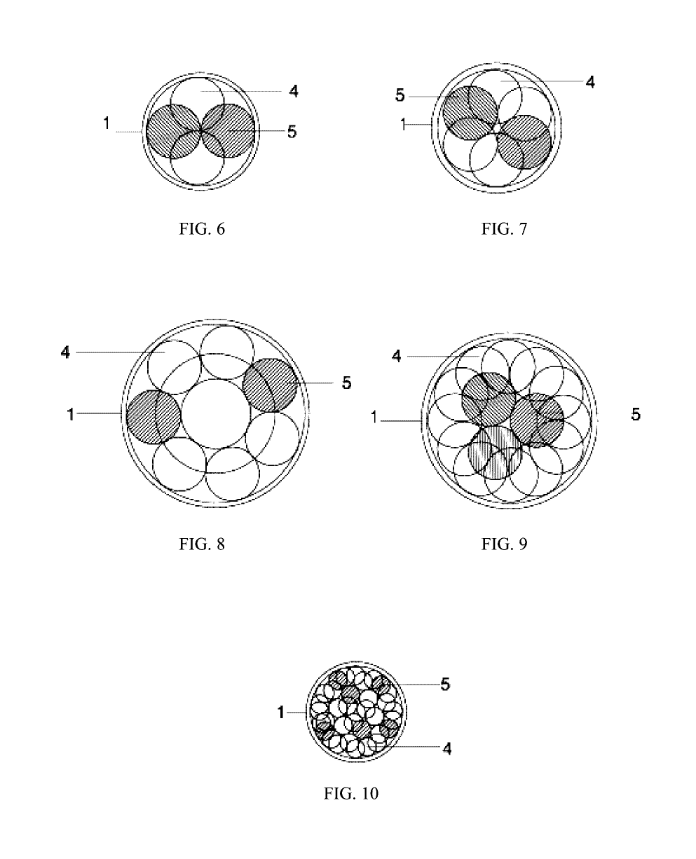

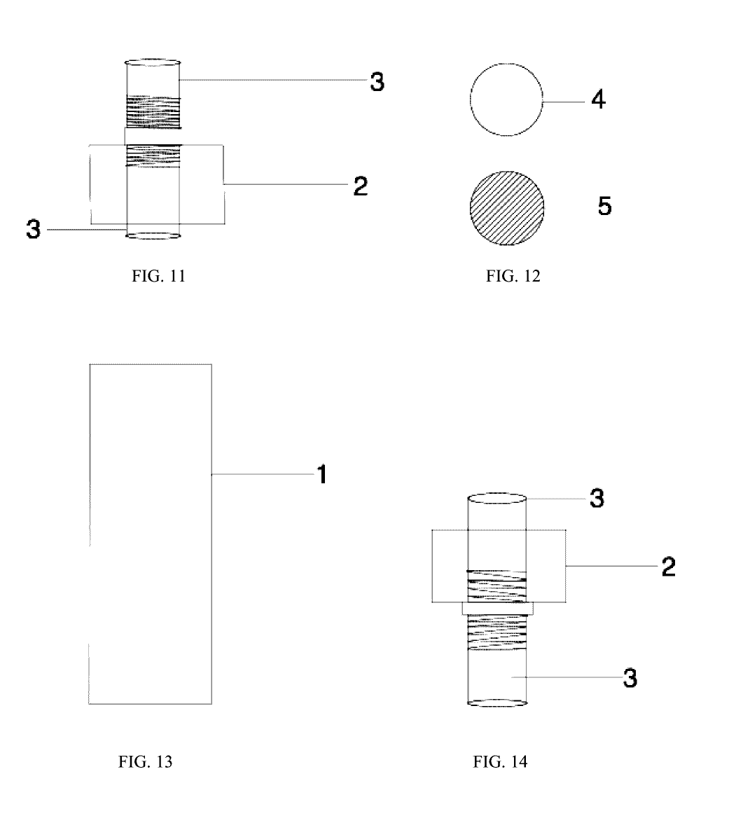

(FIGS. 1, 2, 3, 4, 5) designates an apparatus or assembly including a means for treating a starting liquid in order to break, cluster, and re-cluster the molecules thereof within a piezoelectric, infrared, and magnetic field. This invention is also a means of inducing gasses into liquids; such as oxygen into water. As a starting material water, e.g. tap water, but any form of water or potentially any liquid may be used and thus potentially improved by passing this water through the mixing station 1 of this invention. The invention will be described hereinafter with reference to water. It is, however, to be understood that the invention may be applied to other arbitrary liquids as well.

(FIGS. 1,2,3,4,5) illustrate completed models of this invention, wherein the water flows through an entry tube/pipe 3 into the body of the invention which will be referred to hereinafter as the “mixing station” 1. After flowing into and through the mixing station 1, as well as over and through the materials 4-5 within the mixing station, the water then exits this invention through a pipe 3 mounted at the opposite side of this invention.

The mixing station is filled with various types of materials in the form of spheres 4-5, which fill the body or the “mixing station” 1 of this invention. These spheres 4-5 can be of any size and of any number, as long as they fit into the mixing station. The spheres 4 are each composed of piezoelectric, pyroelectric, pyroluminescent/thermoluminescent, metallic, and/or magnetically conductive materials, as well as other organic and inorganic materials that can have energizing or purifying/filtration effects to water. The materials composing these spheres 4 include, but are not limited; to quartz, sapphire, tourmaline, topaz, ruby, citrine, diamond, volcanic materials, shunghite, loadstone, iron, silver, gold, platinum, palladium, various ceramic materials, carbon, and each of these materials are either shaped, carved, compressed or otherwise formed into sphere/ball shapes of varying sizes. The spheres 4 are made of materials that have each been shown to have effects on the chemical, physical-structural, as well as electric and magnetic properties of water. This invention combines various energetic, filtration, conductive, and productive materials in the form of spheres 4 to create water with specific chemical, energetic, magnetic, and molecular structural/physical properties in water that can be specifically suited to specific and countless applications.

This invention also incorporates spheres 5 that are made of magnetic materials. These magnetic spheres 5 can be composed of any magnetic or magnetized materials, however; rare-earth, neodynium and sumarian cobalt are the preferred form of magnets incorporated into this invention. The purpose of the magnetic spheres 5 is to create the most intense and directed magnetic fields within the mixing station 1, as well as to compress the piezoelectric spheres 4 between the magnetic spheres 5, all within the mixing station 1 of this invention. These spheres 4-5 are placed together in the mixing station 1 and thus creating an amorphous or a geometric arrangement of spheres within the mixing station. This creates a matrix of these magnetic, piezoelectric, and otherwise vibrationally and energetically interacting spheres 4-5 within the mixing station 1. The interaction between the magnetic and magnetically conductive spheres, compresses the piezoelectric spheres 4 within the matrix of spherical magnets 5. The metals, crystals, ceramics, and gemstone spheres 4 are compressed between spheres of magnetic and magnetically conductive spheres 5. These spheres 4-5 are stacked inside the mixing station 1 in various geometric patterns (depending on the application and size of the spheres) in order to accomplish magnetic interactions, magnetic fields, and magnetic torsions (compressions) between other magnetic spheres 5, and the iron, loadstone, magnetite spheres, and the piezoelectric crystal spheres 4, that have all been geometrically and strategically stacked within the mixing station 1 for maximum magnetic compressions and interactions between the magnetic materials and piezoelectric materials.

Further physical compression of the spheres 4-5 inside of the mixing station 1, as well as increased magnetic field interactions and tensions between the piezoelectric and magnetic spheres 4-5 and the water flowing through the inside of the mixing station can be accomplished by adding magnets 6 onto the outside of the mixing station, and/or magnetic rings 6 to encircle the circumference of mixing station. These magnets and/or magnetic rings 6 can be polarized in various manners, and can be attached to the outside of the mixing station 1 with straps, glues/epoxy, bolts, screws, or the magnets may be held to the mixing station 1 by magnetic interactions with the magnetic materials 4-5 that are within the mixing station 1, or the magnets 6 can be magnetically attached to the materials composing the mixing station 1 itself. These magnets 6 can be of any shape, size, or strength (grass rating), and can be set up anywhere on or around the mixing station 1 in order to interact North or South pole magnetism into the mixing station 1 as well as into the spheres 4-5, and into the water flowing through the mixing station 1. The magnets 6 involved in this part of this invention, can be neodynium, sumarian cobalt, ferrus, or any other magnetized materials. Water is passed through the piezoelectric and magnetic field of the created within the mixing station of this invention, and thus the water is emparted with electric, magnetic, physical, and/or chemical changes due to being passed through the compressed materials within this invention.

Further compression of these spheres and the piezoelectric materials is accomplished with a cap pipe fitting 2 that is designed to cap the materials inside of the mixing station 1, as well as to compress the spheres 4-5 by making contact with the spheres necessary to provide compression onto all of the spheres 4-5 within the mixing station 1. The pipe 3 is threaded through the one or both caps 2 of the mixing station 1. With the pipe that is threaded through the caps 2, and into the mixing station 1, and then down onto the spheres 4-5, extreme compression forces can be applied to the spheres 4-5 within the mixing station 1, and thus further activating the piezoelectricity of the quartz, ceramics, and other piezoelectric materials 4 inside of the mixing station 1. The cap 2 itself is either screwed or welded onto the ends of the mixing station. Each cap 2 has a threaded hole or a nut attached to the cap 2. This threaded cap accepts a pipe 3 that is threaded through the cap and down into the mixing station 1, and onto the spheres 4-5 within the mixing station 1. These are the entry and exit pipes 3 that allows water to flow into, through, and exit the mixing station 1. These pipes 3 may have filters, plates, prongs, or other materials attached or welded to the end of these pipes 3 in order to contact and thereby compress specific spheres within the mixing station, while not allowing spheres 4-5 to flow into the entry or exit pipes 3. These pipes 3 are threaded down into the mixing station until the desired compression onto the spheres inside of the mixing station is achieved, or the caps 2 with the pipes inserted to a desired depth, can simply be compressed and then welded/saudered onto the mixing station. With variations of this simple design, vast compressive forces can be applied to the piezoelectric materials 4 that are within the mixing station 1.

The actions of the mixing station 1 of this invention, can be accomplished with several shapes of mixing stations. So the mixing station can vary in shape, and scaled to most any size to handle the desired water flows (gallons per minute), as well as to achieve a specific desired function. The mixing station 1 of this invention can be designed to fit into designated spaces, as well as to accommodate various aestitic/artistic designs. An example of an alternative shape of the mixing station 1 is shown as FIG. 5. The mixing station 1, can be made of any material that can withstand the necessary water pressure and compression pressures. These include, but are not limited to; plastics, pvc, polycarbonate, most metals such as iron, steel, stainless steel, copper, brass, as well as stones, crystals, clay, ceramics, magnets, teflon, carbon, wood. The only limitation to the material composition of the mixing station 1, is the hardness and capability to of the materials to be machined or tooled to the degree necessary to accommodate the desired flow-rate and desired compression of the piezoelectric spheres 4 of this invention.

The spheres 4-5 contained and compressed within the mixing station 1 can be set an any array inside of the mixing station 1. The spheres 4-5 inside of the mixing station 1 can be of any size, any number, and set in any array whether geometric or amorphous. The spheres 4-5 are stacked in a desired array that will accomplish the desired water flow, as well to interact the spheres to provide compression onto the spheres by using magnetism and the end caps 2 specified in this invention.

Infrared producing materials such as NIKKEI ceramics, as well as other ceramic and crystalline sources are carved or molded into spheres, and placed within the geometric matrix of quartz, gemstone, magnetic, and piezoelectric spheres. These infrared energies are amplified, lensed, and re-lensed by the optical aspects of quartz, amythist, and gemstone materials, and can be further cohered and directed by sumarian cobalt magnetism. Thus, this infrared energy is improved by means of this lensing effect, and can be further directed by action of Sumarian Cobalt magnets used on the outside 6 and/or the inside 5 of the mixing station 1.

Phosphorescent materials such as Yittrium and Europium are combined with melted glass, quartz, and/or other gemstone materials to create synthetic glowing/phosphorescent stones. These glowing stones can be manipulated to create certain blue, green, red, and purple light frequencies. These materials can be carved or molded into spheres, and placed inside of the mixing station 1. In this invention, these stones serve to create certain desired colors and spectrums within the mixing station 1, and may be either aesthetic and/or part of the desired function. Other natural, synthetic stones, and composite stones are carved or molded into spheres, and compressed within the mixing station 1 of this invention for their piezoelectric, magnetic, infrared, light, or other energetic potentials and filtration effects.

Pressurized gasses including, but not limited to: Oxygen, Hydrogen, Aragon, and most any other gas can be introduced into this invention by being pumped from their tank into valve 7 or a shaft 7 that can be installed in the side, top, or bottom of the mixing station 1, or this valve 7 may be installed onto the pipe 3 entering the mixing station 1. This valve 7 will allow for the introduction desired gasses into the mixing station 1, and thereby into the water flowing and being conditioned inside of the mixing station 1. The vortex and centrifugal actions, as well as the continual folding and unfolding of the water flowing over the spheres in the mixing station, creates an ideal environment for these gasses to be physically, chemically and electrically combined into water's molecular structure.

Natural gems, minerals, and metals, as well as synthetic, laboratory produced, and composite materials can be used in this invention with similar piezoelectric and otherwise energetic, magnetic, chemical, or physical interactions with liquids in this system. The spheres 4-5 described in this invention may be of slight variances, and may be shapes similar to a sphere such as in the shape of golf balls. So the spheres 4-5 of this invention may have other geometric or imperfect surfaces that will still create and have much of the same effect and function of the sphere shaped materials described in this invention.

Changes may be made in the combination and arrangement of parts or elements and steps and procedures without departing from the spirit and scope of the invention as defined in the following claims.

The invention claimed is:

1. A system for treatment of an agricultural and drinking water, as well as for other fluids containing H2O water molecules comprising:
a ‘mixing station’ that is in flow communication with a source of fluids wherein the fluid is pumped or flowed through a pipe, tube, or hose that is attached to the entry pipe on one end of this device's ‘mixing station’ and flows out through a pipe, tube, or hose on the other end, having first passed through the mixing station.

2. The said mixing station (1) of claim 1 being an encasing tube, or pipe which may be made of a wide variety of including metals, ceramics, plastics, clay, stones, crystalline materials, carbon, magnetic materials, wood, PVC, polycarbonate, and/or composite materials or any other materials that can contain both the water and compressive pressures necessary and allow for entry and exit of fluids.

3. The said mixing station of claim 1 contains sphere-like materials being sphere-like, egg-shaped, golf ball-shaped, and/or other similar geometric shapes, that are inside of the mixing station (1).

4. The sphere-like materials of claim 3 being a stacked array of piezoelectric, pyroelectric, pyroluminescent, gemstone, mineral, rare-earth, magnetic, metallic, ceramic, carbon, phosphorescent light, and/or infrared producing materials, as well as other materials that may assist in the changing the chemical, structural, electric, magnetic, and/or energetic properties of the fluid flowing through this invention.

5. The materials of claim 3 are compressed to specific/desired PSI, thereby activating piezoelectric and other energetic properties of the materials, as well as stimulating vibrational interactions between the materials involved through the compressed contact between the materials within the ‘mixing station’.

6. The compression of claim 5 is accomplished with a threaded, glued, or welded pipe ends (3) and caps (2) that are on either end of the mixing station, and are designed and used in such a way that when they are screwed, glued, welded, or otherwise attached to the ends of the mixing station, compression is applied uniformly to the array of spheres that are exposed on the top/entry and the bottom/exit of said mixing station.

7. The said mixing station (1) of claim 1 may contain piezoelectric materials (4) interacting with magnetic materials (5) to cause further compression to the piezoelectric materials due to the magnetic forces that can be created within the geometric matrix of the piezoelectric and magnetic spheres.

9. Magnets (6) of any shape, size, number, material composition, and polarity can be attached permanently or temporarily to the exterior or interior of the mixing station of claim 1, to cause further magnetic interaction, influence, and/or compression of the piezoelectric materials between magnetically conductive inside of the mixing station of claim 1.

10. Oxygen, Hydrogen, or other gasses may be pumped directly into the mixing station of claim 1, and/or into the fluid entry/supply pipes (3) near or at the entry of the mixing station, using a gas valve stem (7) that is hooked to a gas supply and supply line, thereby supplying the desired gas into the liquid flowing and vortexing into and/or through the mixing station.
